(19) United States
(12) Patent Application Publication
(10) Pub. No.: US 2026/0139977 A1
(43) Pub. Date: May 21, 2026

(54) SENSOR SIGNAL INTERPOLATION METHOD, SENSOR, TERMINAL DEVICE, AND STORAGE MEDIUM

(71) Applicant: HUNAN CHNTEK SENSOR TECHNOLOGY CO., LTD, CHANGSHA (CN)

(72) Inventors: GUOQIU WANG, CHANGSHA (CN); WEI LIANG, CHANGSHA (CN)

(21) Appl. No.: 19/449,381

(22) Filed: Jan. 14, 2026

Related U.S. Application Data
(63) Continuation of application No. PCT/CN2023/117111, filed on Sep. 5, 2023.

(51) Int. Cl. G01D 21/00

(52) U.S. Cl. CPC G01D 21/00

(57) ABSTRACT

Provided is a sensor signal interpolation method, which includes the following steps: calculating N measured points xᵢ of a measured signal x by using a non-equidistant interpolation method, in which i=0, 1, . . . , N−1, then converting the calculated N measured points x₀, x₁, . . . , x_{N-1} to obtain N corresponding electrical signals yᵢ, and then combining xᵢ and yᵢ into a data pair to obtain N interpolation points (xᵢ, yᵢ); according to the above N interpolation points (xᵢ, yᵢ), performing polynomial interpolation to calculate an interpolation function y=f(x), and obtaining, by a sensor, a magnitude of the measured signal x by solving an equation for an electrical signal y according to the interpolation function y=f(x), and establishing a corresponding relationship between the electrical signal y and the measured signal x.

### TECHNICAL FIELD

The present disclosure belongs to the technical field of sensors, and in particular, relates to a sensor signal interpolation method, a sensor using the interpolation method, a terminal device, and a storage medium.

### BACKGROUND

A sensor is a device or an apparatus that can sense a specified measured signal and convert the signal into a usable signal according to a specific rule, and usually consists of a sensitive element or a combination of a sensitive element and a conversion element. The sensitive element directly senses information of the measured signal, and outputs a physical quantity signal or an electrical signal which has a definite relationship with the measured signal. The conversion element may convert the physical quantity signal output by the sensitive element into the electrical signal. Subsequently, the electrical signal output by the conversion element can be conditioned, amplified and converted by the conversion circuit to output a standard voltage, current or digital signal. Because of inconsistency of original output signals, it is sometimes necessary to condition output electrical signals in a sensor manufacturing process to obtain a standard voltage, current or digital signal. A commonly used standard current signal ranges from 4 to 20 mA, or a voltage signal ranges 0.5 to 4.5V, and the like. The measured signal corresponds to a current or voltage value. Generally, the measured signal x has a maximum value M. M is referred to as a range. When the sensitive element works, there is a function relationship between the output electrical signals y and x, which can be denoted as y=f(x). However, the function relationship of y=f(x) is unknown or inaccurate before a sensor signal is conditioned. It is necessary to obtain the function relationship of y=f(x) between y and x through a limited number of sampling points xᵢ and their corresponding electrical signal values yᵢ, and then any electrical signal y output by the sensor can be adjusted (such as nonlinearly compensated) according to y=f(x) to generate a target signal that is more convenient for subsequent processing and use. At present, polynomial interpolation is substantially used to obtain the function relationship of y=f(x).

At present, an interpolation or adjustment theory substantially uses equidistant sampling, that is, xᵢ=iM/(N−1), in which i=0, 1, . . . , N−1, and N denotes the number of sampling or interpolation points. Distances between adjacent points in these sampling points are all the same (equidistant interpolation), and are all M/(N−1). The output sensor signals are mainly linear and approximate to straight line segments. Although this sampling mode is simple, in the face of some complex signals, there may be a Runge oscillation phenomenon. That is, as N is increased, an interpolation function value may significantly deviate from an original signal, so that processed data deviate from real data, thereby affecting performance of the sensor.

### SUMMARY

The present disclosure provides a sensor signal interpolation method, a sensor using the interpolation method, a terminal device, and a storage medium, so that a signal output by the sensor is more accurate.

In a first aspect, the present disclosure provides a sensor signal interpolation method, including the following steps:
calculating N measured points xᵢ of a measured signal x by using a non-equidistant interpolation method, where a calculation formula is:

$${x}_{i} = \frac{sin \frac{i + 1}{2 N} πsin \frac{i}{2 N} π}{cos \frac{π}{2 N}} M , in which i = 0 , 1 , … , N - 1 \qquad ( 1 )$$

in Formula (1), “sin” denotes a sine function, “cos” denotes a cosine function, N denotes the number of measured points, and M denotes a range of the measured signal of a sensor;
converting the N measured points x₀, x₁, . . . , x_{N-1} obtained by Formula (1) to obtain N corresponding electrical signals yᵢ;
combining xᵢ and yᵢ into a data pair to obtain N interpolation points (xᵢ, yᵢ), in which i=0, 1, . . . , N−1;
according to the above N interpolation points (xᵢ, yᵢ), performing polynomial interpolation to calculate an interpolation function y=f(x):

$$y = {\sum }_{i = 0}^{N - 1} {y}_{i} {\prod }_{j = 0 , j \neq i}^{N - 1} \frac{x - {x}_{j}}{{x}_{i} - {x}_{j}} \qquad ( 2 )$$

in Formula (2), “Σ” denotes summation, and “Π” denotes a product symbol; and
obtaining, by the sensor, a magnitude of the measured signal x by solving an equation for an electrical signal y according to the interpolation function y=f(x), and establishing a corresponding relationship between the electrical signal y and the measured signal x.

In a second aspect, the present disclosure provides a sensor applied to the sensor signal interpolation method described above, including:
a sensitive element, which is configured to sense a measured signal x and convert the measured signal x into an electrical signal y;
an interpolation point acquisition module, which is configured to calculate N measured points xᵢ (i=0, 1, . . . , N−1) of the measured signal x according to Formula (1), and after the sensitive element converts the calculated N measured points into N corresponding electrical signals yᵢ, combine xᵢ and yᵢ into a data pair to obtain N interpolation points (xᵢ, yᵢ), in which i=0, 1, . . . , N−1; and
an interpolation function module, which is configured to calculate an interpolation function y=f(x) from N interpolation points (xᵢ, yᵢ) obtained in the interpolation point acquisition module according to a method shown in Formula (2), then obtain a magnitude of the measured signal x by solving an equation for the electrical signal y according to the interpolation function y=f(x), and establish a corresponding relationship between the electrical signal y and the measured signal x.

In a third aspect, the present disclosure provides another sensor, which is also applied to the sensor signal interpolation method described above, including:
a sensitive element, which is configured to sense a measured signal x and output a physical quantity signal having a definite relationship with the measured signal x;
a conversion element, which is configured to convert the physical quantity signal output by the sensitive element into an electrical signal y;
an interpolation point acquisition module, which is configured to calculate N measured points xᵢ (i=0, 1, . . . , N−1) of the measured signal x according to Formula (1), and after the conversion element converts the calculated N measured points into N corresponding electrical signals yᵢ, combine xᵢ and yᵢ into a data pair to obtain N interpolation points (xᵢ, yᵢ), in which i=0, 1, . . . , N−1; and
an interpolation function module, which is configured to calculate an interpolation function y=f(x) from N interpolation points (xᵢ, yᵢ) obtained in the interpolation point acquisition module according to a method shown in Formula (2), then obtain a magnitude of the measured signal x by solving an equation for the electrical signal y according to the interpolation function y=f(x), and establish a corresponding relationship between the electrical signal y and the measured signal x.

In a fourth aspect, the present disclosure provides a terminal device, including a memory, a processor, and a computer program stored in the memory and executable on the processor, where the processor, when executing the computer program, implements the sensor signal interpolation method as described in the first aspect.

In a fifth aspect, the present disclosure provides a computer-readable storage medium, in which a computer program is stored, where the computer program, when executed by a processor, implements the sensor signal interpolation method as described in the first aspect.

According to the sensor signal interpolation method provided by the present disclosure, interpolation points are calculated by a non-equidistant interpolation method, so that an error resulted from equidistant interpolation in the prior art is overcome, an impact of a Runge oscillation phenomenon is effectively avoided, fitting accuracy is higher, an error is smaller, and original signals collected by a sensitive element of the sensor can be deeply restored. In this way, the sensor can obtain more accurate measurement values, and accuracy of the sensor can be improved.

### BRIEF DESCRIPTION OF THE DRAWINGS

FIG. 1 is a flowchart of a sensor signal interpolation method according to the present disclosure;

FIG. 2A is a comparison diagram of an original signal when N=15 in Embodiment 1 of the present disclosure and an equidistant interpolation function signal in the prior art;

FIG. 2B is a comparison diagram of an original signal when N=15 in Embodiment 1 of the present disclosure and a non-equidistant interpolation function signal according to the present disclosure;

FIG. 3A is a first comparison diagram of an original signal when N=16 in Embodiment 2 of the present disclosure and an equidistant interpolation function signal in the prior art;

FIG. 3B is a first comparison diagram of an original signal when N=16 in Embodiment 2 of the present disclosure and a non-equidistant interpolation function signal according to the present disclosure;

FIG. 4A is a second comparison diagram of an original signal when N=16 in Embodiment 2 of the present disclosure and an equidistant interpolation function signal in the prior art;

FIG. 4B is a second comparison diagram of an original signal when N=16 in Embodiment 2 of the present disclosure and a non-equidistant interpolation function signal according to the present disclosure;

FIG. 5A is a third comparison diagram of an original signal when N=16 in Embodiment 2 of the present disclosure and an equidistant interpolation function signal in the prior art;

FIG. 5B is a third comparison diagram of an original signal when N=16 in Embodiment 2 of the present disclosure and a non-equidistant interpolation function signal according to the present disclosure;

FIG. 6A is a fourth comparison diagram of an original signal when N=16 in Embodiment 2 of the present disclosure and an equidistant interpolation function signal in the prior art;

FIG. 6B is a fourth comparison diagram of an original signal when N=16 in Embodiment 2 of the present disclosure and a non-equidistant interpolation function signal according to the present disclosure;

FIG. 7 is a schematic diagram of an embodiment of a sensor according to the present disclosure;

FIG. 8 is a schematic diagram of an embodiment of another sensor according to the present disclosure; and

FIG. 9 is a schematic diagram of an embodiment of a terminal device according to the present disclosure.

### DETAILED DESCRIPTION OF THE EMBODIMENTS

In the following description, for the purpose of illustration rather than limitation, specific technical features are set forth for a thorough understanding of the embodiments of the present disclosure. However, it should be clear to those skilled in the art that the present disclosure can be implemented in other embodiments without these specific technical features. In other cases, detailed description of well-known systems, apparatuses, circuits, and methods is omitted so as not to obscure description of the present disclosure with unnecessary details.

It should be appreciated that a term “include”, when used in the specification and append claims of the present disclosure, indicates presence of the described feature, integer, step, operation, element, and the like, but does not exclude presence or addition of one or more of other features, integers, steps, operations, elements and/or groups thereof.

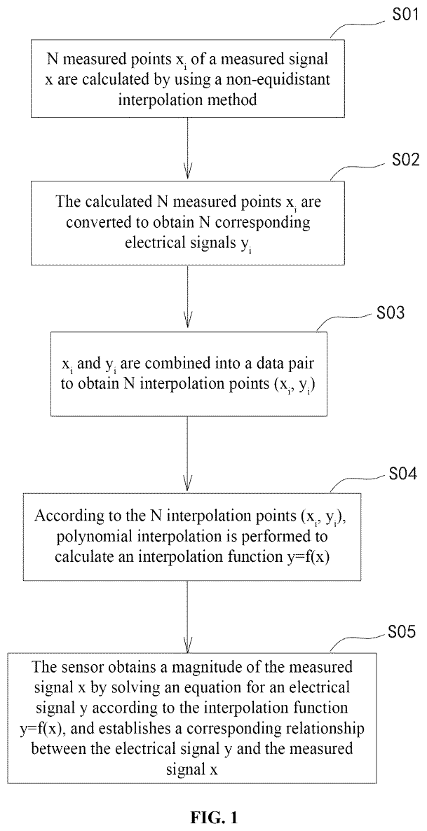

Referring to FIG. 1, the present disclosure first provides a sensor signal interpolation method, including the following steps.

S01, N measured points xᵢ of a measured signal x are calculated by using a non-equidistant interpolation method.

A calculation formula is:

$${x}_{i} = \frac{sin \frac{i + 1}{2 N} πsin \frac{i}{2 N} π}{cos \frac{π}{2 N}} M , in which i = 0 , 1 , … , N - 1 \qquad ( 1 )$$

in Formula (1), “sin” denotes a sine function, “cos” denotes a cosine function, N denotes the number of measured points, and M denotes a range of the measured signal x of the sensor.

The sensor senses external information, such as a force, a distance, a temperature, light, sound, chemical composition, and the like (the measured signal x), through the sensitive element. According to the above calculation Formula (1), N measured points xᵢ of the measured signal x may be obtained, and information of each measuring point xᵢ may be input into the sensitive element.

The sensor includes but is not limited to a pressure sensor, a displacement sensor, an image sensor, a speed sensor, a strain sensor, a temperature sensor, and a humidity sensor.

Taking a pressure sensor as an example, when N=5 and M (range)=1 (MPa), the following approximation values of the measured points xᵢ can be obtained by using the above calculation Formula (1):
{0, 0.190983, 0.5, 0.809017, 1}
{0, 0.2, 0.5, 0.8, 1}
{0, 0.19, 0.5, 0.81, 1}
{0, 0.191, 0.5, 0.809, 1}
{0, 0.19098, 0.5, 0.80902, 1}.

When N=6 and M is arbitrary, M here can be any physical quantity that can be measured by a sensitive element of the sensor. The following approximate values of the measured points xᵢ can be obtained by using the above calculation Formula (1):
{0, 0.133975M, 0.366025M, 0.633975M, 0.866025M, M}
{0, 0.13M, 0.37M, 0.63M, 0.87M, M}
{0, 0.134M, 0.366M, 0.634M, 0.866M, M}
{0, 0.13398M, 0.36603M, 0.63398M, 0.86603M, M}.

When N=7 and M is arbitrary, M here can be any physical quantity that can be measured by the sensitive element of the sensor. The following approximate values of the measured points xᵢ can be obtained by using the above calculation Formula (1):
{0, 0.0990311M, 0.277479M, 0.5M, 0.722521M, 0.900969M, M}
{0, 0.1M, 0.3M, 0.5M, 0.7M, 0.9M, M}
{0, 0.0M, 0.28M, 0.5M, 0.72M, 0.90M, M}
{0, 0.099M, 0.277M, 0.5M, 0.723M, 0.901M, M}
{0, 0.0990M, 0.2775M, 0.5M, 0.7225M, 0.9010M, M}.

S02, the N measured points x₀, x₁, . . . , x_{N-1} obtained by the above Formula (1) are converted to obtain N corresponding electrical signals yᵢ.

In this step, the sensitive element may be used to convert the N measured points x₀, x₁, . . . , x_{N-1} obtained by the above calculation Formula (1) into corresponding electrical signals y₀, y₁, . . . , y_{N-1}. The sensitive element may also be used to first convert the N measured points x₀, x₁, . . . , x_{N-1} obtained by the above calculation Formula (1) preliminarily into physical quantity signals having a definite relationship with x₀, x₁, . . . , x_{N-1}, and then the conversion element may be used to convert the physical quantity signals into corresponding electrical signals y₀, y₁, . . . , y_{N-1}.

When the electrical signal y is very weak, so that the signal may not be directly collected, the signal may be amplified by an amplifier circuit.

S03, xᵢ and yᵢ are combined into a data pair to obtain N interpolation points (xᵢ, yᵢ), in which i=0, 1, . . . , N−1.

S04, according to the above N interpolation points (xᵢ, yᵢ), polynomial interpolation is performed to calculate an interpolation function y=f(x).

The specific calculation formula is:

$$y = {\sum }_{i = 0}^{N - 1} {y}_{i} {\prod }_{j = 0 , j \neq i}^{N - 1} \frac{x - {x}_{j}}{{x}_{i} - {x}_{j}} \qquad ( 2 )$$

where “Σ” denotes summation, and “Π” denotes a product symbol.

For convenience of illustration, the following formula is used:

$${l}_{i} ( x ) = {\prod }_{j = 0 , j \neq i}^{N - 1} \frac{x - {x}_{j}}{{x}_{i} - {x}_{j}} \qquad ( 3 )$$

Still taking the pressure sensor as an example, when N=5, Formula (3) includes the following five quartic polynomial functions:

$${l}_{0} ( x ) = {\prod }_{j = 0 , j \neq 0}^{N - 1} \frac{x - {x}_{j}}{{x}_{0} - {x}_{j}} = ( x - {x}_{1} ) ( x - {x}_{2} ) ( x - {x}_{3} ) ( x - {x}_{4} ) / ( {x}_{0} - {x}_{1} ) ( {x}_{0} - {x}_{2} ) ( {x}_{0} - {x}_{3} ) ( {x}_{0} - {x}_{4} )$$

$${l}_{1} ( x ) = {\prod }_{j = 0 , j \neq 1}^{N - 1} \frac{x - {x}_{j}}{{x}_{1} - {x}_{j}} = ( x - {x}_{0} ) ( x - {x}_{2} ) ( x - {x}_{3} ) ( x - {x}_{4} ) / ( {x}_{1} - {x}_{0} ) ( {x}_{1} - {x}_{2} ) ( {x}_{1} - {x}_{3} ) ( {x}_{1} - {x}_{4} )$$

$${l}_{2} ( x ) = {\prod }_{j = 0 , j \neq 2}^{N - 1} \frac{x - {x}_{j}}{{x}_{2} - {x}_{j}} = ( x - {x}_{0} ) ( x - {x}_{1} ) ( x - {x}_{3} ) ( x - {x}_{4} ) / ( {x}_{2} - {x}_{0} ) ( {x}_{2} - {x}_{1} ) ( {x}_{2} - {x}_{3} ) ( {x}_{2} - {x}_{4} )$$

$${l}_{3} ( x ) = {\prod }_{j = 0 , j \neq 3}^{N - 1} \frac{x - {x}_{j}}{{x}_{3} - {x}_{j}} = ( x - {x}_{0} ) ( x - {x}_{1} ) ( x - {x}_{2} ) ( x - {x}_{4} ) / ( {x}_{3} - {x}_{0} ) ( {x}_{3} - {x}_{1} ) ( {x}_{3} - {x}_{2} ) ( {x}_{3} - {x}_{4} )$$

$${l}_{4} ( x ) = {\prod }_{j = 0 , j \neq 4}^{N - 1} \frac{x - {x}_{j}}{{x}_{4} - {x}_{j}} = ( x - {x}_{0} ) ( x - {x}_{1} ) ( x - {x}_{2} ) ( x - {x}_{3} ) / ( {x}_{4} - {x}_{0} ) ( {x}_{4} - {x}_{1} ) ( {x}_{4} - {x}_{2} ) ( {x}_{4} - {x}_{3} )$$

Then, Formula (2) is:

$$y = {y}_{0} {l}_{0} ( x ) + {y}_{1} {l}_{1} ( x ) + {y}_{2} {l}_{2} ( x ) + {y}_{3} {l}_{3} ( x ) + {y}_{4} {l}_{4} ( x ) \qquad ( 4 )$$

S05, the sensor obtains a magnitude of the measured signal x by solving an equation for an electrical signal y according to the interpolation function y=f(x), and establishes a corresponding relationship between the electrical signal y and the measured signal x, so as to obtain the corresponding magnitude of the measured object for any electrical signal y.

After the interpolation method is completed in the present disclosure, the electrical signal y may be conditioned and converted into a voltage, current or digital signal for output as required, thereby improving adaptability and usability of the sensor signal.

Specific conditioning includes but is not limited to nonlinear compensation or/and null load output zeroing or/and signal amplification or/and conversion into a standard digital current or voltage. Various conditioning can be implemented separately or in combination as required.

Conditioning of the sensor signal may further include a process such as isolation and protection.

The above method is applied to the interpolation output by the electrical signal of the sensor at various stages, and is applied to both analog sensors and digital sensors.

In the above method of the present disclosure, for a polynomial interpolation function signal of Formula (2) obtained using the measuring point xᵢ of Formula (1), a Runge oscillation phenomenon may not occur again, so that an original signal collected by the sensitive element of the sensor can be truly restored, and the sensor can obtain more accurate measurement values.

According to the above interpolation method, the sensor can be finally conditioned. The calibration software can be designed and developed. A detection device can be designed and manufactured. This has a wide application prospect.

It should be noted that the above description only represents some basic steps of the present disclosure, and the sequence of steps does not strictly represents the sequence of steps of the method protected by the present disclosure. Those skilled in the art can add some steps according to the actual situation, and the sequence of steps can also be exchanged, merged and split. The above steps are only examples of one sequence of interpolation methods.

The application embodiments of the interpolation method of the present disclosure are as follows.

### Embodiment 1

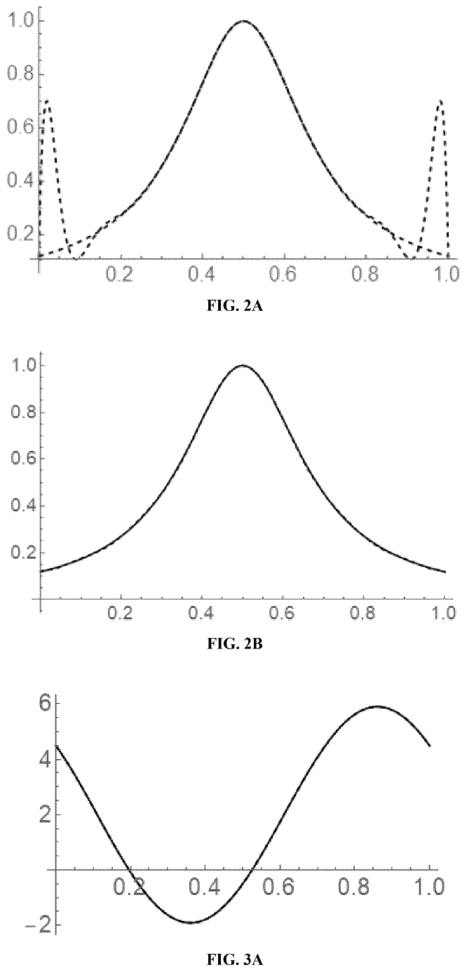

Take a signal source R(x)=1/(1+30(x−0.5)²). For N=15, that is, 15 interpolation points, when equidistant interpolation in the prior art is used, an image of an original signal and an image of an interpolation function signal are shown in FIG. 2A. When the interpolation point uses the non-equidistant interpolation method of the present disclosure, the image of the original signal and the image of the interpolation function signal are shown in FIG. 2B, in which a solid line denotes the original signal R(x), and a dotted line denotes the interpolation signal.

As can be seen from FIG. 2A, when equidistant interpolation is used, the interpolation function signal (a dotted line) obviously has peaks at both ends of the original signal (a solid line), that is, the equidistant interpolation function signal has a Runge oscillation phenomenon. The interpolation function signal is significantly different from the original signal, so that the processed data deviate from the real data. However, in FIG. 2B, the non-equidistant interpolation function signal (a dotted line) of the present disclosure is almost completely coincident with the original signal (a solid line), that is, the interpolation signal fitted with the non-equidistant interpolation function of the present disclosure may not produce a Runge oscillation phenomenon, and the original signal can be substantially restored.

### Embodiment 2

In order to avoid an incomparable impact resulted from a measurement error, four signal sources distributed in the interval [0, 1] are selected.

Specifically, the following original signals are selected:

$${f}_{1} ( x ) = 3 sin ( 2 π x - π ) - 2 \cdot 5 cos ( 2 π x - π ) + 2 \qquad ( 5 )$$

In Formula (5), sin denotes a sine function, and cos denotes a cosine function;

$${f}_{2} ( x ) = \frac{10 x - 5}{1 + {( 10 x - 5 )}^{4}} \qquad ( 6 )$$

$${f}_{3} ( x ) = \frac{1}{1 + 25 {( x - 0.5 )}^{2}} \qquad ( 7 )$$

$${f}_{4} ( x ) = arctan ( 10 x - 5 ) \qquad ( 8 )$$

“arctan” in Formula (8) denotes an arctan function.

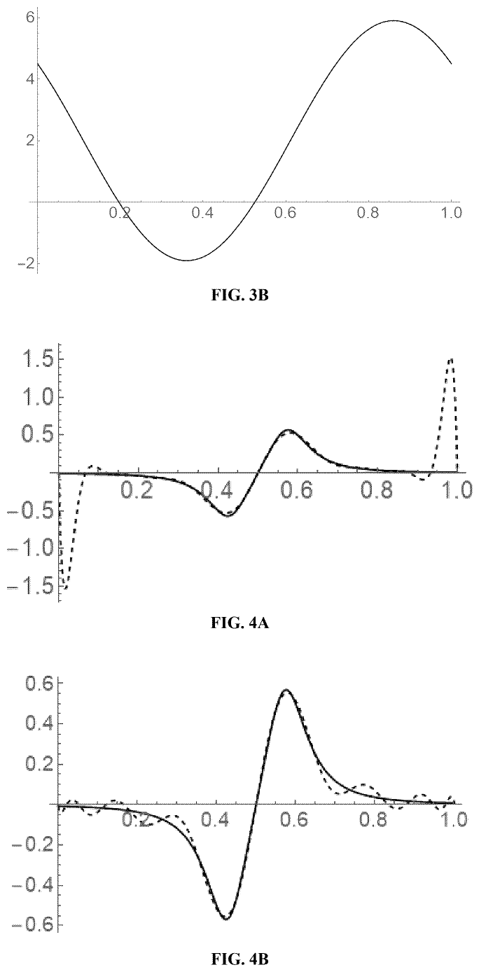

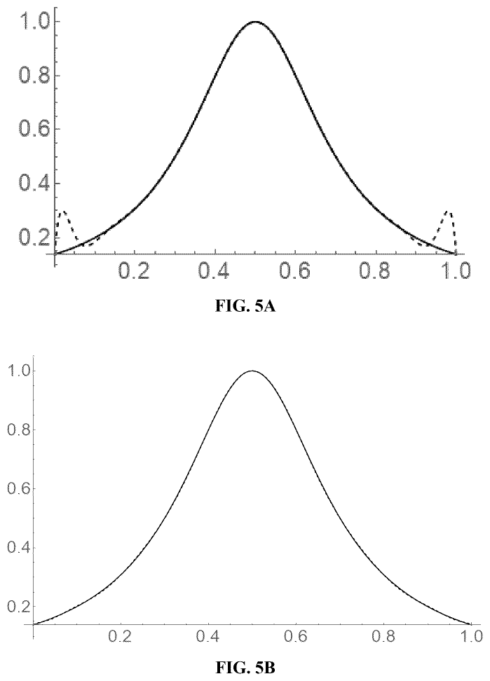

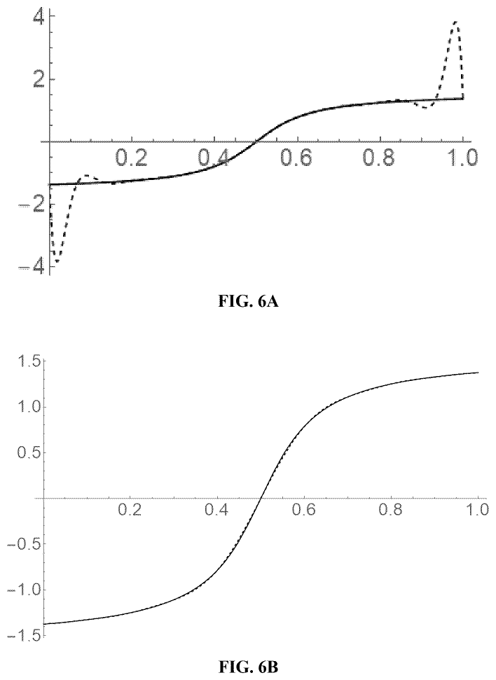

When N=16, images of an original signal and an equidistant interpolation function are shown in FIG. 3A, FIG. 4A, FIG. 5A, and FIG. 6A, where the original signal in FIG. 3A is f₁(x) in Formula (5), the original signal in FIG. 4A is f₂(x) in Formula (6), the original signal in FIG. 5A is f₃(x) in Formula (7), and the original signal in FIG. 6A is f₄(x) in Formula (8). The solid line denotes the original signal, and the dotted line denotes the equidistant interpolation function signal. As can be seen from the figure, when the original signal is f₁(x), the equidistant interpolation function signal is substantially the same as the original signal (see FIG. 3A), and there is no Runge oscillation phenomenon. However, when the original signals are f₂(x), f₃(x) and f₄(x), there is a great difference between the equidistant interpolation function signals and the original signals, and the signals at both ends of the figure deviate and have specific peaks (see FIG. 4A, FIG. 5A and FIG. 6A). That is, when the original signals are f₂(x), f₃(x) and f₄(x) described above, a strong Runge oscillation phenomenon occurs, so that accuracy of the sensor is reduced.

When N=16, images of an original signal and a non-equidistant interpolation function of the present disclosure are shown in FIG. 3B, FIG. 4B, FIG. 5B, and FIG. 6B. Similarly, the original signal of FIG. 3B is f₁(x) in Formula (5), the original signal in FIG. 4B is f₂(x) in Formula (6), the original signal in FIG. 5B is f₃(x) in Formula (7), and the original signal in FIG. 6B is f₄(x) in Formula (8). The solid line denotes the original signal, and the dotted line denotes the non-equidistant interpolation function signal. As can be seen from the figure, the original signals in FIG. 3B, FIG. 5B, and FIG. 6B are almost completely coincident with the non-equidistant interpolation function signals. That is, there is no Runge oscillation phenomenon in the non-equidistant interpolation function signals. Although FIG. 4B is not completely coincident with the original signals, no Runge oscillation phenomenon occurs. The images of the non-equidistant interpolation function signals are very close to the images of the original signals, and the value deviating from the original signals is also very small.

Therefore, for the polynomial interpolation function signal of Formula (2) obtained by the measuring point xᵢ of Formula (1) in the present disclosure, a Runge oscillation phenomenon may not occur again.

For the case of N interpolation points, L_{N}(f) is denoted as an interpolation function, that is, y in the above Formula (2). Max|L_{N}(f)−f(x)∥ is used to denote a maximum error between the interpolation function signal and the original signal, which can be appreciated as accuracy of the sensor. Based on the original signal, f₁(x) in Formula (5), f₂(x) in Formula (6), f₃(x) in Formula (7), and f₄(x) in Formula (8) are calculated to have results as shown in Table 1 when N is 8, 12, 16, and 20 respectively.

TABLE 1
Maximum Interpolation Error

| N | | 8 | 12 | 16 | 20 |
|---|---|---|---|---|---|
| f₁(x) | Equidistant | 0.0176798 | 3.01600e−5 | 1.55005e−8 | 2.2729e−12 |
| | node | | | | |
| | Non- | 0.0054661 | 2.70793e−6 | 3.6851e−10 | 1.19904e−14 |
| | equidistant | | | | |
| | node | | | | |
| f₂(x) | Equidistant | 1.4420000 | 4.6423100 | 1.5229200 | 120.51900 |
| | node | | | | |
| | Non- | 0.3462080 | 0.2020420 | 0.0615256 | 0.0498239 |
| | equidistant | | | | |
| | node | | | | |
| f₃(x) | Equidistant | 0.096408 | 0.112218 | 0.152910 | 0.223864 |
| | node | | | | |
| | Non- | 0.093280 | 0.019270 | 0.00401 | 0.000838 |
| | equidistant | | | | |
| | node | | | | |
| f₄(x) | Equidistant | 0.396306 | 0.867457 | 2.462420 | 8.001650 |
| | node | | | | |
| | Non- | 0.085394 | 0.002971 | 0.010398 | 0.003865 |
| | equidistant | | | | |
| | node | | | | |

In Table 1, the “equidistant node” is the polynomial expression L_{N}(F) obtained by performing interpolation on equidistant sampling points in the prior art, and then Max|L_{N}(f)−f1(x)|) is calculated. The “non-equidistant node” is the polynomial expression L_{N}(F) obtained by performing interpolation on the measured point xᵢ calculated by Formula (1), and then Max|L_{N}(f)−f1(x)|) is calculated.

As can be seen from Table 1, data based on non-equidistant interpolation points is much better than data based on equidistant interpolation points. Even for f₁(x) having no Runge oscillation phenomenon, as shown in FIG. 3A and FIG. 3B (N=16), although there is no difference therebetween in the figures, from results in Table 1, results based on the non-equidistant interpolation points are improved by an order of magnitude compared with results based on the equidistant interpolation points. For f₂(x), f₃(x) and f₄(x) having a Runge oscillation phenomenon, when the equidistant interpolation function is used, the Runge oscillation phenomenon is obvious, and the error is divergent. For the non-equidistant interpolation points, the Runge oscillation phenomenon has been eliminated, and the error may gradually decrease when N is increased. When the number of interpolation points N tends to infinity, the non-equidistant interpolation signal is completely the same as the original signal. Therefore, the interpolation signal calculated by the non-equidistant interpolation function of the present disclosure may allow the sensor to obtain accurate measurement values.

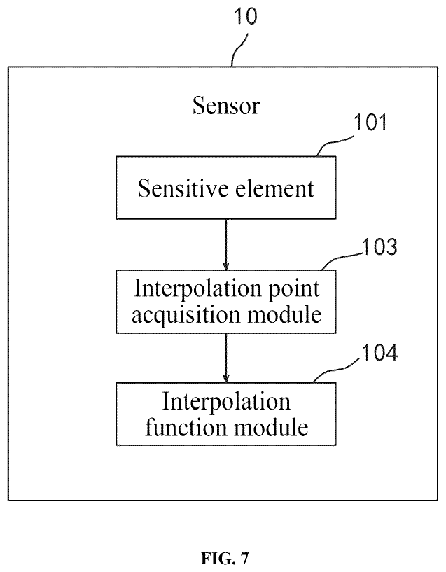

Referring to FIG. 7, the present disclosure further provides an embodiment of a sensor 10 constructed based on the above method. The sensor 10 of this embodiment includes modules for executing steps in the corresponding embodiment of FIG. 1. For convenience of illustration, only parts related to this embodiment are shown.

The sensor 10 may include:
a sensitive element 101, which is configured to sense measured information (measured signals x) of a target object, such as physical, chemical, biological and other information, and then convert these measured signals x into corresponding electrical signals y;
an interpolation point acquisition module 103, which is configured to first calculate N measured points xᵢ (i=0, 1, . . . , N−1) of the measured signal x according to Formula (1), then select the calculated N measured points xᵢ, and after the sensitive element 101 converts the calculated N measured points into corresponding electrical signals yᵢ (i=0, 1, . . . , N−1), combine the measured points xᵢ and the electrical signals yᵢ into a data pair to obtain N interpolation points (xᵢ, yᵢ), in which i=0, 1, . . . , N−1; and
an interpolation function module 104, which is configured to calculate an interpolation function y=f(x) from N interpolation points (xᵢ, yᵢ) obtained in the interpolation point acquisition module 103 according to a method shown in Formula (2), then obtain a magnitude of the measured signal x by solving an equation for the electrical signal y according to the interpolation function y=f(x), and establish a corresponding relationship between the electrical signal y and the measured signal x.

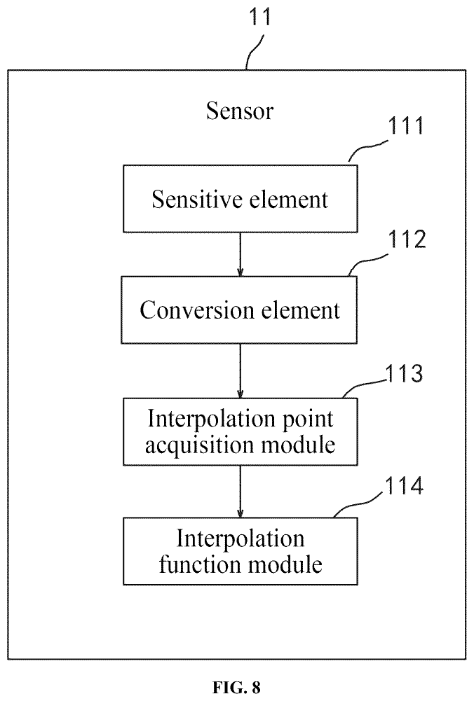

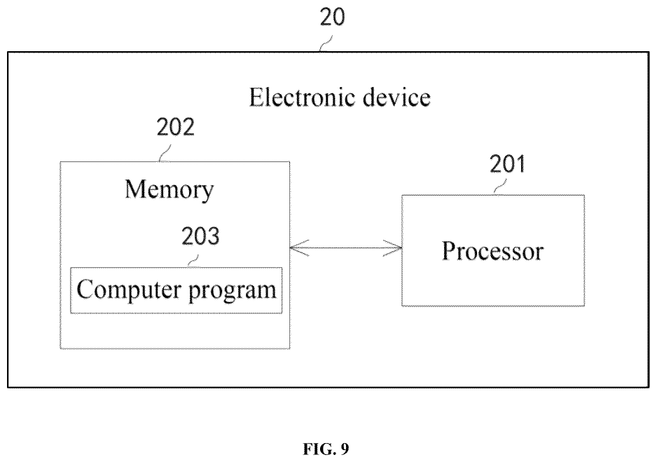

Referring to FIG. 8, the present disclosure further provides an embodiment of another sensor 11 constructed based on the above method. The sensor 10 of this embodiment includes modules for executing steps in the corresponding embodiment of FIG. 1. For convenience of illustration, only parts related to this embodiment are shown.

The sensor 11 may include:
a sensitive element 111, which is configured to sense measured information (measured signals x) of a target object, such as physical, chemical, biological and other information, and then convert the measured information into a physical quantity signal having a definite relationship with the measured signal x;
a conversion element 112, which is configured to convert the physical quantity signal output by the sensitive element 111 into an electrical signal y;
an interpolation point acquisition module 113, which is configured to first calculate N measured points xᵢ (i=0, 1, . . . , N−1) of the measured signal x according to Formula (1), then select the calculated N measured points xᵢ, convert the signal of the measured points xᵢ into the physical quantity signal by the sensitive element 111, convert the physical quantity signal into electrical signals yᵢ (i=0, 1, . . . , N−1) corresponding to N measured points xᵢ by the conversion element 112, and finally combine the measured points xᵢ and the electrical signals yᵢ into a data pair to obtain N interpolation points (xᵢ, yᵢ), in which i=0, 1, . . . , N−1; and
an interpolation function module 114, which is configured to calculate an interpolation function y=f(x) from N interpolation points (xᵢ, yᵢ) obtained in the interpolation point acquisition module 113 according to a method shown in Formula (2), then obtain a magnitude of the measured signal x by solving an equation for the electrical signal y according to the interpolation function y=f(x), and establish a corresponding relationship between the electrical signal y and the measured signal x.

The above sensors 10 and 11 may further include a post-processing module, which may be a single module or circuit or a combination of a plurality of modules or circuits, and may be configured to perform nonlinear compensation or/and null load output zeroing or/and signal amplification or/and conversion into a standard digital current or voltage on the electrical signal y.

FIG. 9 is a block diagram of a structure of a terminal device according to the present disclosure. As shown in FIG. 9, the terminal device 20 of this embodiment includes a processor 201, a memory 202, and a computer program 203 stored in the memory 202 and capable of operating the above sensor signal interpolation method on the processor 201. The processor 201, when executing the computer program 203, implements steps in each embodiment of the foregoing sensor signal interpolation method, or the processor 201, when executing the computer program 203, implements functions of each module in the foregoing embodiments corresponding to FIG. 7 and FIG. 8.

It may be appreciated that the computer program 203 can be divided into one or more modules. The one or more modules are stored in the memory 202 and executed by the processor 201 to implement the sensor signal interpolation method provided by the present disclosure. The one or more modules may be a series of computer program instruction segments capable of completing specific functions. The instruction segments are used to describe the execution process of the computer program 203 in the terminal device 20. For example, the computer program 203 can implement the sensor signal interpolation method provided by the embodiment of the present disclosure.

The terminal device 20 includes but is not limited to a processor 201 and a memory 202. It may be appreciated by those skilled in the art that FIG. 9 is only an example of the terminal device 20, and does not constitute a limitation on the terminal device 20. More or less components than shown may be included, or some components or different components may be combined. For example, the terminal device may further include an input and output device, a network access device, a bus, and the like.

The processor 201 may be a central processing unit, another general processor, a digital signal processor, and the like. The general processor may be a microprocessor, or the processor may be any conventional processor, and the like.

The memory 202 may be an internal storage unit of the terminal device 20, such as a hard disk or a memory, or an internal storage unit or/and an external storage device equipped on the terminal device 20.

The present disclosure further provides a computer-readable storage medium, which includes a memory, a processor, and a computer program stored in the memory and executable on the processor. The processor, when executing the computer program, implements the sensor signal interpolation method in the above embodiments.

In addition, the present disclosure may further provide a computer program product. The computer program product, when operating on the terminal device, causes the terminal device to implement the sensor signal interpolation method in the above embodiments.

The above embodiments are only used to illustrate the technical solution of the present disclosure, rather than limit the technical solution. Although the present disclosure has been described in detail with reference to the foregoing embodiments, it should be appreciated by those skilled in the art that the technical solutions described in the foregoing embodiments may be still modified, or some technical features may be substituted with equivalents. However, these modifications or substitutions do not make the essence of the corresponding technical solutions deviate from the spirit and scope of the technical solutions of various embodiments of the present disclosure, and should be included in the scope of protection of the present disclosure.

What is claimed is:

1. A sensor signal interpolation method, comprising the following steps:
calculating N measured points xᵢ of a measured signal x by using a non-equidistant interpolation method, wherein a calculation formula is:
$${x}_{i} = \frac{sin \frac{i + 1}{2 N} πsin \frac{i}{2 N} π}{cos \frac{π}{2 N}} M , in which i = 0 , 1 , … , N - 1 \qquad ( 1 )$$
in Formula (1), “sin” denotes a sine function, “cos” denotes a cosine function, N denotes the number of measured points, and M denotes a range of the measured signal of a sensor;
converting the N measured points x₀, x₁, . . . , x_{N-1} obtained by Formula (1) to obtain N corresponding electrical signals yᵢ;
combining xᵢ and yᵢ into a data pair to obtain N interpolation points (xᵢ, yᵢ), in which i=0, 1, . . . , N−1;
according to the above N interpolation points (xᵢ, yᵢ), performing polynomial interpolation to calculate an interpolation function y=f(x):
$$y = {\sum }_{i = 0}^{N - 1} {y}_{i} {\prod }_{j = 0 , j \neq i}^{N - 1} \frac{x - {x}_{j}}{{x}_{i} - {x}_{j}} \qquad ( 2 )$$
in Formula (2), “Σ” denotes summation, and “Π” denotes a product symbol; and
obtaining, by the sensor, a magnitude of the measured signal x by solving an equation for an electrical signal y according to the interpolation function y=f(x), and establishing a corresponding relationship between the electrical signal y and the measured signal x.

2. The sensor signal interpolation method according to claim 1, wherein the electrical signal y is conditioned after establishing a corresponding relationship between the electrical signal y and the measured signal x.

3. The sensor signal interpolation method according to claim 2, wherein conditioning the electrical signal y comprises nonlinear compensation or/and null load output zeroing or/and signal amplification or/and conversion into a standard digital current or voltage.

4. The sensor signal interpolation method according to claim 1, wherein according to the calculation Formula (1) of the N measured points xᵢ of the measured signal x of the sensor, when N=5 and M=1, the following approximation values of the measured points xᵢ are obtained:
{0, 0.190983, 0.5, 0.809017, 1}
{0, 0.2, 0.5, 0.8, 1}
{0, 0.19, 0.5, 0.81, 1}
{0, 0.191, 0.5, 0.809, 1}
{0, 0.19098, 0.5, 0.80902, 1}.

5. The sensor signal interpolation method according to claim 1, wherein according to the calculation Formula (1) of the N measured points xᵢ of the measured signal x of the sensor, when N=6 and M is arbitrary, the following approximation values of the measured points xᵢ are obtained:
{0, 0.133975M, 0.366025M, 0.633975M, 0.866025M, M}
{0, 0.13M, 0.37M, 0.63M, 0.87M, M}
{0, 0.134M, 0.366M, 0.634M, 0.866M, M}
{0, 0.13398M, 0.36603M, 0.63398M, 0.86603M, M}.

6. The sensor signal interpolation method according to claim 1, wherein according to the calculation Formula (1) of the N measured points xᵢ of the measured signal x of the sensor, when N=7 and M is arbitrary, the following approximation values of the measured points xᵢ are obtained:
{0, 0.0990311M, 0.277479M, 0.5M, 0.722521M, 0.900969M, M}
{0, 0.1M, 0.3M, 0.5M, 0.7M, 0.9M, M}
{0, 0.0M, 0.28M, 0.5M, 0.72M, 0.90M, M}
{0, 0.099M, 0.277M, 0.5M, 0.723M, 0.901M, M}
{0, 0.0990M, 0.2775M, 0.5M, 0.7225M, 0.9010M, M}.

7. A sensor applied to the sensor signal interpolation method according to claim 1, comprising:
a sensitive element, which is configured to sense a measured signal x and convert the measured signal x into an electrical signal y;
an interpolation point acquisition module, which is configured to calculate N measured points xᵢ (i=0, 1, . . . , N−1) of the measured signal x according to Formula (1), and after the sensitive element converts the calculated N measured points into N corresponding electrical signals yᵢ, combine xᵢ and yᵢ into a data pair to obtain N interpolation points (xᵢ, yᵢ), in which i=0, 1, . . . , N−1; and
an interpolation function module, which is configured to calculate an interpolation function y=f(x) from N interpolation points (xᵢ, yᵢ) obtained in the interpolation point acquisition module according to a method shown in Formula (2), then obtain a magnitude of the measured signal x by solving an equation for the electrical signal y according to the interpolation function y=f(x), and establish a corresponding relationship between the electrical signal y and the measured signal x.

8. A sensor applied to the sensor signal interpolation method according to claim 1, comprising:
a sensitive element, which is configured to sense a measured signal x and output a physical quantity signal having a definite relationship with the measured signal x;
a conversion element, which is configured to convert the physical quantity signal output by the sensitive element into an electrical signal y;
an interpolation point acquisition module, which is configured to calculate N measured points xᵢ (i=0, 1, . . . , N−1) of the measured signal x according to Formula (1), and after the conversion element converts the calculated N measured points into N corresponding electrical signals yᵢ, combine xᵢ and yᵢ into a data pair to obtain N interpolation points (xᵢ, yᵢ), in which i=0, 1, . . . , N−1; and
an interpolation function module, which is configured to calculate an interpolation function y=f(x) from N interpolation points (xᵢ, yᵢ) obtained in the interpolation point acquisition module according to a method shown in Formula (2), then obtain a magnitude of the measured signal x by solving an equation for the electrical signal y according to the interpolation function y=f(x), and establish a corresponding relationship between the electrical signal y and the measured signal x.

9. A terminal device, comprising a memory, a processor, and a computer program stored in the memory and executable on the processor, wherein the processor, when executing the computer program, implements the sensor signal interpolation method according to claim 1.

10. A computer-readable storage medium, in which a computer program is stored, wherein the computer program, when executed by a processor, implements the sensor signal interpolation method according to claim 1.
